(19) United States
(12) Patent Application Publication
(10) Pub. No.: US 2022/0166014 A1
(43) Pub. Date: May 26, 2022

(54) SURFACE TREATMENT SOLUTION, METHOD FOR PREPARING SURFACE TREATMENT SOLUTION, METHOD FOR PREPARING ACTIVE MATERIAL USING SURFACE TREATMENT SOLUTION, AND ACTIVE MATERIAL PREPARED THEREBY

(71) Applicants: HYUNDAI MOTOR COMPANY, Seoul (KR); Kia Corporation, Seoul (KR); Dong-A University Research Foundation for Industry-Academy Cooperation, Busan (KR)

(72) Inventors: Sang Mok PARK, Gwangju-si (KR); Ik Kyu KIM, Gwangmyeong-si (KR); Yeol Mae YEO, Hwaseong-si (KR); Seung Min OH, Incheon (KR); Sa Heum KIM, Suwon-si (KR); Yoon Sung LEE, Suwon-si (KR); Nam Hyeong KIM, Gimcheon-si (KR); Ji Eun LEE, Hwaseong-si (KR); Dong Jun KIM, Seongnam-si (KR); Sung Ho BAN, Hwaseong-si (KR); Jeom Soo KIM, Hwaseong-si (KR); Seung Hyun KIM, Busan (KR)

(73) Assignees: HYUNDAI MOTOR COMPANY, Seoul (KR); Kia Corporation, Seoul (KR); Dong-A University Research Foundation for Industry-Academy Cooperation, Busan (KR)

(21) Appl. No.: 17/533,678

(22) Filed: Nov. 23, 2021

(30) Foreign Application Priority Data
Nov. 24, 2020 (KR) 10-2020-0159074

(51) Int. Cl. H01M 4/505; H01M 4/525; H01M 10/0525

(52) U.S. Cl. CPC H01M 4/505; H01M 2004/028; H01M 10/0525; H01M 4/525

(57) ABSTRACT

Disclosed are a method for preparing an active material, the surface of which is modified, using a surface treatment solution and an active material prepared thereby, and more particularly, an active material in which the amount of impurities on the surface thereof is reduced and on the surface of which a metal oxide configured to cut off direct contact with an electrolyte is uniformly disposed by collectively performing both a washing process and a surface treatment process using a surface treatment solution having a novel composition.

### CROSS-REFERENCE TO RELATED APPLICATION

This application claims priority under 35 U.S.C. § 119(a) to Korean Patent Application No. 10-2020-0159074 filed on Nov. 24, 2020, the entire contents of which are incorporated herein by reference.

### TECHNICAL FIELD

The present disclosure relates to a method for preparing an active material, the surface of which is modified, using a surface treatment solution and an active material prepared thereby. More particularly, it relates to an active material in which the amount of impurities on the surface thereof is reduced and on the surface of which a metal oxide configured to cut off direct contact with an electrolyte is uniformly disposed by collectively performing both a washing process and a surface treatment process using a surface treatment solution having a novel composition.

### BACKGROUND

A cathode active material primarily releases lithium in a lithium ion secondary battery, and is a main material which may increase the energy density of the lithium ion secondary battery. A trivalent transition metal oxide including Ni, Mn or Co, which is used as a representative cathode material applied to lithium secondary batteries used for electric vehicles, has a layered structure, and recently tends to increase the content of Ni in order to realize energy improvement. However, as the content of Ni is increased, the generation rate of lithium compounds, such as lithium carbonate, lithium hydroxide, etc., on the surface of the cathode material is increased, and the lithium compounds degrade the performance of the battery.

Conventionally, a separate washing process is performed in order to remove the lithium compounds which are unnecessarily additionally produced, or a heat treatment process is performed to treat the surface of the cathode material. However, the addition of such a process may increase complexity in a process for preparing the active material.

The above information disclosed in this Background section is only for enhancement of understanding of the background of the disclosure and therefore it may contain information that does not form the prior art that is already known in this country to a person of ordinary skill in the art.

### SUMMARY OF THE DISCLOSURE

The present disclosure has been made in an effort to solve the above-described problems associated with the prior art, and it is an object of the present disclosure to provide a method which may effectively remove lithium compounds remaining on the surface of an active material.

It is another object of the present disclosure to provide a method which may modify the surface of an active material so as to form a uniform coating layer on the surface of the active material.

It is still another object of the present disclosure to provide a method which may simplify a process for preparing an active material.

It is yet another object of the present disclosure to provide a method which may simultaneously perform removal of lithium compounds remaining on the surface of an active material and modification of the surface of the active material.

In one aspect, the present disclosure provides a method for preparing a surface treatment solution, the method including preparing a mixed solution including a metal source, a dispersant and an organic solvent, hydrolyzing the metal source by adding water to the mixed solution, and performing hydrothermal synthesis in the mixed solution, wherein the metal source includes a metal alkoxide.

In a preferred embodiment, in the preparing of the mixed solution, the metal source may include a transition metal element having tetravalent cations.

In another preferred embodiment, in the preparing of the mixed solution, the metal source may include one of titanium (Ti), germanium (Ge) and tin (Sn).

In still another preferred embodiment, in the preparing of the mixed solution, the metal alkoxide may be one of titanium isopropoxide, germanium isopropoxide and tin isopropoxide.

In yet another preferred embodiment, in the preparing of the mixed solution, the dispersant may include tetrabutylammonium hydroxide.

In still yet another preferred embodiment, in the preparing of the mixed solution, the organic solvent may include one selected from the group consisting of isopropanol, ethanol, acetone and combinations thereof.

In a further preferred embodiment, in the hydrolyzing of the metal source, a weight ratio of the organic solvent in the mixed solution to the water may be 2:8 to 4:6.

In another further preferred embodiment, in the performing of the hydrothermal synthesis, hydrothermal reaction may be allowed to progress in the mixed solution at a temperature of 100 to 180° C. for 0.5 to 3 hours.

In another aspect, the present disclosure provides a surface treatment solution prepared by the above-described method, the surface treatment solution including a solvent including the organic solvent and the water, and a metal oxide including one of titanium(IV) oxide (TiO₂), germanium oxide (GeO₂) and tin(IV) oxide (SnO₂).

In a preferred embodiment, the organic solvent may include one selected from the group consisting of isopropanol, ethanol, acetone and combinations thereof.

In still another aspect, the present disclosure provides a method for preparing an active material, the method including preparing a base active material including adducts formed on a surface thereof, preparing an active material mixed solution by mixing the base active material and the above-described surface treatment solution, agitating the active material mixed solution, obtaining a composite material by removing the solvent from the active material mixed solution, and heat-treating the composite material.

In a preferred embodiment, in the preparing of the base active material, the adducts formed on the surface of the base active material may include lithium carbonate (Li₂CO₃) and lithium hydroxide (LiOH).

In another preferred embodiment, in the preparing of the base active material, the base active material may include a lithium metal oxide indicated by Chemical Formula 1 below,

LiₐNiₓMn_{y}M_{1-x-y}O₂, [Chemical Formula 1]

wherein, a, x and y may respectively satisfy 0.9≤a≤1.2, 0.7≤x≤0.95 and 0.01≤y≤0.30, and M may include one of Co, Al, Mg, Fe, Cu, Zn, Cr and V.

In still another preferred embodiment, in the preparing of the active material mixed solution, a weight ratio of the base active material to the surface treatment solution may be 1:1 to 1:1.5.

In yet another preferred embodiment, in the agitating of the active material mixed solution, the adducts may be removed from the surface of the base active material by the solvent, and the surface of the base active material may be modified by the metal oxide.

In still yet another preferred embodiment, in the agitating of the active material mixed solution, the active material mixed solution may be agitated for 6 to 15 minutes.

In a further preferred embodiment, in the obtaining of the composite material, the composite material may include the base active material and the metal oxide.

In another further preferred embodiment, in the heat-treating of the composite material, the composite material may be heat-treated at a temperature of 200 to 600° C. for 1 to 6 hours.

In still another further preferred embodiment, in the heat-treating of the composite material, a lithium metal oxide may be produced by reaction of the adducts with the metal oxide caused by the heat treatment of the composite material.

In yet another aspect, the present disclosure provides an active material prepared by the above-described method, the active material including the metal oxide including one of titanium(IV) oxide (TiO₂), germanium oxide (GeO₂) and tin(IV) oxide (SnO₂), and a lithium metal oxide.

Other aspects and preferred embodiments of the disclosure are discussed infra.

The above and other features of the disclosure are discussed infra.

### BRIEF DESCRIPTION OF THE DRAWINGS

The above and other features of the present disclosure will now be described in detail with reference to certain exemplary embodiments thereof illustrated in the accompanying drawings which are given hereinbelow by way of illustration only, and thus are not limitative of the present disclosure, and wherein:

FIG. 1 is a flowchart showing a method for preparing a surface treatment solution according to the present disclosure;

FIG. 2 is a flowchart showing a method for preparing an active material according to the present disclosure;

FIG. 3 is a process chart of the method for preparing the active material according to the present disclosure;

FIGS. 4A and 4B are views illustrating the composition of the active material according to the present disclosure;

FIGS. 5A and 5B are SEM images of an active material according to Example 1;

FIGS. 6A and 6B are SEM images of an active material according to Comparative Example 1;

FIGS. 7A and 7B are SEM images of an active material according to Comparative Example 2;

FIG. 8 is a graph representing the results of observation of control rates of adducts according to Test Example 2;

FIG. 9 is a graph representing the results of observation of rate capabilities of the active materials according to Example 1 and Comparative Example 2;

FIG. 10 is a graph representing the results of observation of lifetime characteristics of the active materials according to Example 1 and Comparative Example 2;

FIG. 11 is a graph representing the results of observation of control rates of adducts according to Test Example 4;

FIG. 12 is a graph representing the results of observation of rate capabilities of the active materials according to Comparative Example 1 and Example 3;

FIG. 13 is a graph representing the results of observation of discharge capacities of the active materials according to Comparative Example 1 and Example 3;

FIG. 14 is a graph representing the results of observation of lifetime characteristics of the active materials according to Comparative Example 1 and Example 3 at room temperature; and

FIG. 15 is a graph representing the results of observation of lifetime characteristics of the active materials according to Comparative Example 1 and Example 3 at a high temperature.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

The above-described objects, other objects, advantages and features of the present disclosure will become apparent from the descriptions of embodiments given herein below with reference to the accompanying drawings. However, the present disclosure is not limited to the embodiments disclosed herein, and may be implemented in various different forms. The embodiments are provided to make the description of the present disclosure thorough and to fully convey the scope of the present disclosure to those skilled in the art.

In the following description of the embodiments, the same elements are denoted by the same reference numerals even when they are depicted in different drawings. In the drawings, the dimensions of structures may be exaggerated compared to the actual dimensions thereof, for clarity of description. In the following description of the embodiments, terms, such as “first” and “second”, may be used to describe various elements but do not limit the elements. These terms are used only to distinguish one element from other elements. For example, a first element may be named a second element, and similarly, a second element may be named a first element, without departing from the scope and spirit of the disclosure. Singular expressions may encompass plural expressions, unless they have clearly different contextual meanings.

In the following description of the embodiments, terms, such as “including” and “having”, are to be interpreted as indicating the presence of characteristics, numbers, steps, operations, elements or parts stated in the description or combinations thereof, and do not exclude the presence of one or more other characteristics, numbers, steps, operations, elements, parts or combinations thereof, or the possibility of adding the same. In addition, it will be understood that, when a part, such as a layer, a film, a region or a plate, is said to be “on” another part, the part may be located “directly on” the other part or other parts may be interposed between the two parts. In the same manner, it will be understood that, when a part, such as a layer, a film, a region or a plate, is said to be “under” another part, the part may be located “directly under” the other part or other parts may be interposed between the two parts.

All numbers, values and/or expressions representing amounts of components, reaction conditions, polymer compositions and blends used in the description are approximations in which various uncertainties in measurement generated when these values are acquired from essentially different things are reflected and thus, it will be understood that they are to be modified by the term “about”, unless stated otherwise. In addition, it will be understood that, if a numerical range is disclosed in the description, such a range includes all continuous values from a minimum value to a maximum value of the range, unless stated otherwise. Further, if such a range refers to integers, the range includes all integers from a minimum integer to a maximum integer, unless stated otherwise.

In the following description of the embodiments, it will be understood that, when the range of a variable is stated, the variable includes all values within the stated range including stated end points of the range. For example, it will be understood that a range of “5 to 10” includes not only values of 5, 6, 7, 8, 9 and 10 but also arbitrary subranges, such as a subrange of 6 to 10, a subrange of 7 to 10, a subrange of 6 to 9, and a subrange of 7 to 9, and arbitrary values between integers which are valid within the scope of the stated range, such as 5.5, 6.5, 7.5, 5.5 to 8.5, and 6.5 to 9. Further, for example, it will be understood that a range of “10% to 30%” includes not only all integers including values of 10%, 11%, 12%, 13%, . . . 30% but also arbitrary subranges, such as a subrange of 10% to 15%, a subrange of 12% to 18%, and a subrange of 20% to 30%, and arbitrary values between integers which are valid within the scope of the stated range, such as 10.5%, 15.5%, and 25.5%.

The present disclosure relates to a method for preparing a surface treatment solution 10, the surface treatment solution 10 prepared by the method, a method for preparing an active material using the surface treatment solution 10, and the active material prepared by the method.

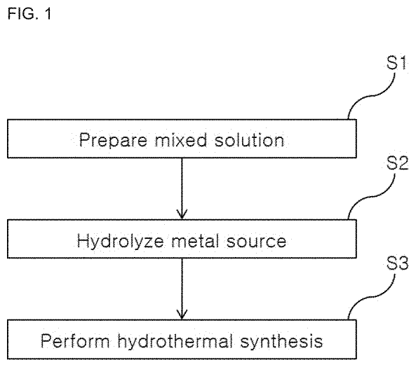

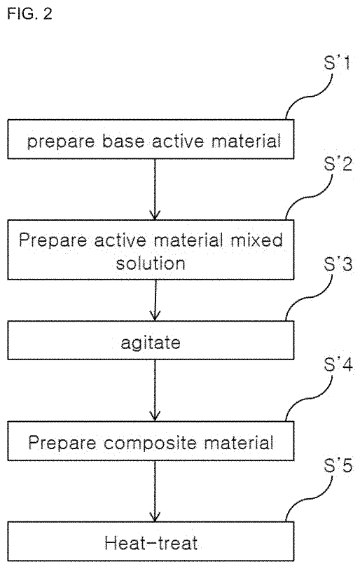

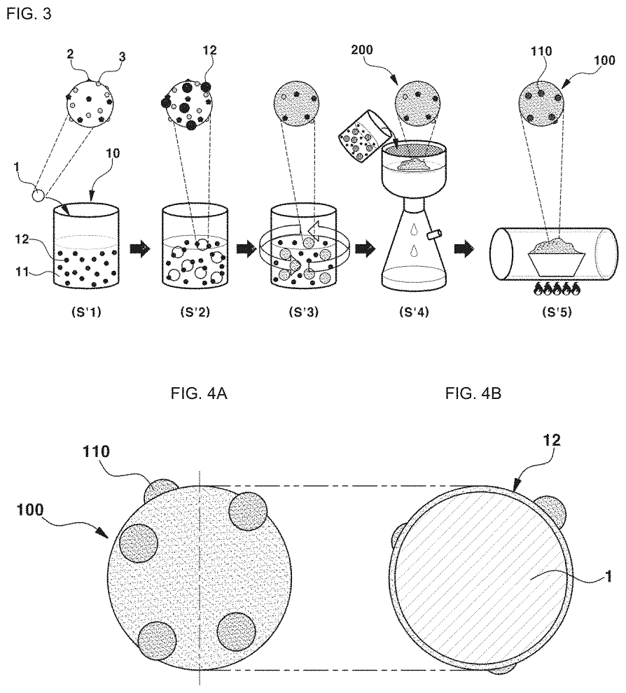

FIGS. 1 and 2 are flowcharts showing the method for preparing the surface treatment solution 10 and the method for preparing the active material and the respective methods will be described with reference to FIGS. 1 and 2, and the surface treatment solution 10 and the active materials prepared by these methods will be described with reference to FIGS. 3, 4A, and 4B.

Method for Preparing Surface Treatment Solution

The method for preparing the surface treatment solution 10 according to the present disclosure includes preparing a mixed solution including a metal source, a dispersant and an organic solvent (S1), hydrolyzing the metal source by adding water to the mixed solution (S2), and performing hydrothermal synthesis in the mixed solution (S3).

Hereinafter, the respective operations will be described with reference to FIG. 1.

Preparation of Mixed Solution (S1)

The mixed solution according to the present disclosure includes the metal source, the dispersant and the organic solvent.

The mixed solution may preferably include 0.8 to 1.2% by weight of the metal source, 0 2 to 0.5% by weight of the dispersant and 98.5 to 98.8% by weight of the organic solvent.

The metal source may include a transition metal element having tetravalent cations, and preferably may include one of titanium (Ti), germanium (Ge) and tin (Sn).

The metal source may include a metal alkoxide, and preferably may include one of titanium isopropoxide, germanium isopropoxide and tin isopropoxide.

In the present disclosure, titanium isopropoxide has the highest efficiency of removal of residual adducts.

The dispersant is used so as to uniformly disperse the metal source in a solvent 11, and preferably may include tetrabutylammonium hydroxide.

The organic solvent serves simply as a solvent, and simultaneously serves to remove adducts remaining on the surface of the active material together with water.

The organic solvent may be one selected from the group consisting of isopropanol, ethanol, acetone and combinations thereof, and preferably may be isopropanol which provides excellent dispensability to the metal source or a metal oxide 12.

Hydrolysis (S2)

The metal source is hydrolyzed by additionally adding water to the mixed solution.

Water is added to the mixed solution one to six times at a final weight ratio of 2:8 to 4:6 of the mixed solution to water for 10 to 60 minutes. Preferably, the weight ratio of the mixed solution to water is 2:8 to 3:7.

Water hydrolyzes the metal source, and the metal source grows into oxide particles by such hydrolysis.

In the present disclosure, the metal source in the form of a metal alkoxide is hydrolyzed, thus growing into the metal oxide 12.

The metal oxide 12 may include one of titanium(VI) oxide (TiO₂), germanium oxide (GeO₂) and tin(IV) oxide (SnO₂).

In the present disclosure, the weight ratio of water to the organic solvent during hydrolysis may influence the dispersibility of the metal oxide 12. Therefore, the weight ratio of the organic solvent to water may preferably be 2:8 to 4:6. The weight ratio of the organic solvent to water may more preferably be 2:8 to 3:7.

Hydrothermal Synthesis (S3)

The mixed solution is subjected to hydrothermal synthesis, and in this case, the metal source having passed through Operation S1 and Operation S2 is induced to disperse as uniform crystalline microparticles under high-temperature and high-pressure conditions.

Here, hydrothermal synthesis may be performed at a temperature of 100 to 180° C. for 0.5 to 3 hours.

Surface Treatment Solution

The surface treatment solution 10 according to the present disclosure is prepared by the method for preparing the method for preparing the surface treatment solution 10 according to the present disclosure, and includes the solvent 11 including the organic solvent and water, and the metal oxide 12.

The metal oxide 12 may preferably include one of titanium(IV) oxide, germanium oxide and tin(IV) oxide.

The organic solvent may be one selected from the group consisting of isopropanol, ethanol, acetone and combinations thereof.

Method for Preparing Active Material

The method for preparing the active material according to the present disclosure includes preparing a base active material 1 including adducts formed on the surface thereof (S′1), preparing an active material mixed solution by mixing the base active material 1 and the surface treatment solution 10 (S′2), agitating the active material mixed solution (S′3), obtaining a composite material by removing the solvent 11 from the active material mixed solution (S′4), and heat-treating the composite material (S′5).

Hereinafter, the respective operations will be described with reference to FIGS. 2 and 3.

Preparation of Base Active Material (S′1)

The base active material 1 including adducts formed on the surface thereof is prepared.

The base active material 1 according to the present disclosure basically includes a lithium metal oxide including nickel (Ni).

The lithium metal oxide includes one selected from the group consisting of nickel, manganese, cobalt, aluminum, magnesium, iron, copper, zinc, chrome, vanadium and combinations thereof, and may preferably include a compound indicated by Chemical Formula 1 below.

LiₐNiₓMn_{y}M_{1-x-y}O₂ [Chemical Formula 1]

In the above Chemical Formula 1, a, x and y respectively satisfy 0.9≤a≤1.2, 0.7≤x≤0.95 and 0.01≤y≤0.30, and M includes one of Co, Al, Mg, Fe, Cu, Zn, Cr and V.

The adducts may be formed on the surface of the base active material 1 due to aging by oxygen, carbon dioxide and moisture in the air.

The adducts include lithium carbonate (Li₂CO₃) 2 and lithium hydroxide (LiOH) 3.

Preparation of Active Material Mixed Solution (S′2)

The active material mixed solution is prepared by adding the base active material 1 to the prepared surface treatment solution 10 according to the present disclosure.

Here, the weight ratio of the base active material 1 to the surface treatment solution 10 may be adjusted to 1:1 to 1:1.5.

The base active material 1 and the metal oxide 12 are dispersed in the solvent 11 according to the present disclosure, and the metal oxide 12 is adhered to portions of the surface of the base active material 1, by mixing, as described above.

Agitation (S′3)

The active material mixed solution is agitated, and due to the agitation, the adducts formed on the surface of the base active material 1 are removed by the solvent 11, and simultaneously, the surface of the base active material 1 is modified by the metal oxide 12.

The agitation may be preferably performed for 6 to 15 minutes, and may be more preferably performed for 6 to 10 minutes. When the agitation time is less than 6 minutes, the removal rate of the adducts from the surface of the base active material 1 may be lowered and the adhesion rate of the metal oxide 12 to the surface of the base active material 1 may be lowered, and when the agitation time exceeds 15 minutes, a side reaction may occur on the surface of the base active material 1 and the performance of the active material may be degraded.

Preparation of Composite Material (S′4)

The composite material is obtained by removing the solvent 11 from the active material mixed solution.

The composite material includes the base active material having the surface from which the most amount of the adducts is removed, and which is modified by the metal oxide 12. The composite material may preferably include the base active material having the surface from which the adducts are completely removed by agitation, and which is modified by the metal oxide 12.

The solvent 11 may be removed by drying the active material mixed solution after filtering the active material mixed solution, and the drying of the active material mixed solution may be performed for 3 to 10 hours.

In the present disclosure, the drying temperature of the active material mixed solution is not limited to a specific temperature, and may be any temperature at which the solvent 11 is capable of being properly removed in the above-described amount of time without an influence on the composite material.

In the present disclosure, impurities other than the composite material are removed through filtration, before drying the active material mixed solution.

Heat Treatment (S′5)

The composite material is heat-treated, and in this case, the heat treatment may be preferably performed at a temperature of 200° C. to 600° C. for 1 to 6 hours. The heat treatment may be more preferably performed at a temperature of 400° C. to 600° C.

The heat treatment induces the adducts remaining on the surface of the composite material to react with the metal oxide 12 so as to synthesize a lithium metal oxide.

The adducts may include one of lithium carbonate 2 and lithium hydroxide 3, and the metal oxide 12 which reacts with the adducts may include one of titanium(IV) oxide, germanium oxide and tin(IV) oxide.

The adducts remaining on the surface of the composite material, which are not removed by agitation, are completely removed by the heat treatment, and thereby, the active material according to the present disclosure is prepared.

Active Material

The active material according to the present disclosure is prepared by the method for preparing the active material according to the present disclosure, and includes the metal oxide 12, which is one of titanium(IV) oxide, germanium oxide and tin(IV) oxide, and a lithium metal oxide.

The active material according to the present disclosure may include adducts formed on the surface thereof, and preferably the adducts may be completely removed from the surface of the active material, and the surface of the active material may be modified by the metal oxide 12 and may include the lithium metal oxide on portions thereof.

FIGS. 4A and 4B briefly illustrate the structure of the active material according to the present disclosure. Referring to these figures, it may be confirmed that the metal oxide 12 is uniformly disposed on the surface of the active material according to the present disclosure and the lithium metal oxide is disposed on portions of the surface of the active material 110.

Hereinafter, the present disclosure will be described in more detail through the following examples. The following examples serve merely to exemplarily describe the present disclosure and are not intended to limit the scope of the disclosure.

### Manufacture Example

A mixed solution including 98.8% by weight of isopropanol, 1% by weight of germanium isopropoxide and 0.2% by weight of tetrabutylammonium hydroxide (TBAOH) was prepared, water was added to the mixed solution at a weight ratio of 3:7 of the mixed solution to water, and then the mixed solution was heated and agitated for 4 hours. Thereafter, hydrothermal synthesis was performed in the mixed solution at a temperature of 150° C. for 2 hours, thereby preparing a surface treatment solution.

### Example 1

A base active material (NiCoMn=90.4:5.7:3.9), which was aged in the air, was prepared, and was added to the surface treatment solution prepared according to above Manufacture Example at the ratio of 1:1, thereby preparing an active material mixed solution. Thereafter, the active material mixed solution was agitated for 10 minutes and then dried for 8 hours, thereby preparing a composite material.

An active material (TS-Ge) was prepared by heat-treating the composite material at a temperature of 500° C. for 5 hours.

### Comparative Example 1

The base active material (Pristine) used in Example 1 was prepared.

### Comparative Example 2

The same amount of water as that of the mixed solution prepared in Manufacture Example was prepared as a solvent, and the base active material used in Example 1 was washed with the solvent. Thereafter, a mixed solution including 98.8% by weight of isopropanol, 1% by weight of germanium isopropoxide and 0.2% by weight of tetrabutylammonium hydroxide (TBAOH) was prepared, and hydrolysis was performed by adding the washed base active material to the mixed solution and adding a small amount of water into the mixed solution. Thereafter, an active material (W&C) was prepared by heat-treating the hydrolyzed mixed solution by the same method as in Example 1.

### Examples 2 and 3

Active materials according to Examples 2 and 3 were prepared using the same process as in Example 1 by adjusting the weight of germanium isopropoxide and the agitation time as set forth in Table 1 below.

TABLE 1

| | Symbol | Ge (% by weight) | Agitation time |
|---|---|---|---|
| Example 1 | Ge(001)_10m | 0.1 | 10 minutes |
| Example 2 | Ge(001)_5m | 0.1 | 5 minutes |
| Example 3 | Ge(002)_5m | 0.3 | 5 minutes |

### Test Example 1 (SEM Analysis)

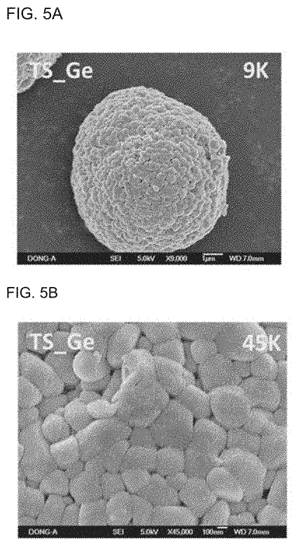

The active materials prepared according to Example 1, Comparative Example 1 and Comparative Example 2 were analyzed using a scanning electron microscope (SEM), and FIGS. 5A to 7B illustrate the results of the analysis.

FIGS. 5A and 5B are SEM images of the active material (TS-Ge) according to Example 1, and show that boundaries between particles are clear due to control of adducts remaining on the surface of the active material (TS-Ge) and the active material (TS-Ge) is relatively uniformly coated with small metal oxide particles.

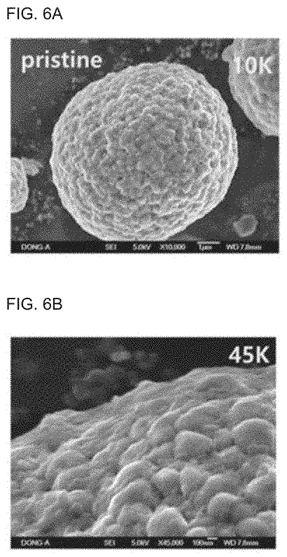

FIGS. 6A and 6B are SEM images of the active material (pristine) according to Comparative Example 1, and show that boundaries between particles are not clear due to an excessive amount of adducts formed on the surface of the active material (pristine).

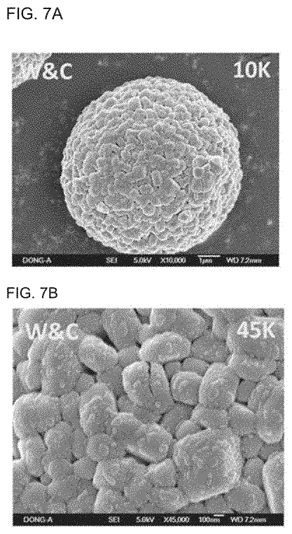

FIGS. 7A and 7B are SEM images of the active material (W&C) according to Comparative Example 2, and show that large-sized metal oxide particles having nonuniform shapes are dispersed on the surface of the active material (W&C).

### Test Example 2 (Control Rate of Adducts)

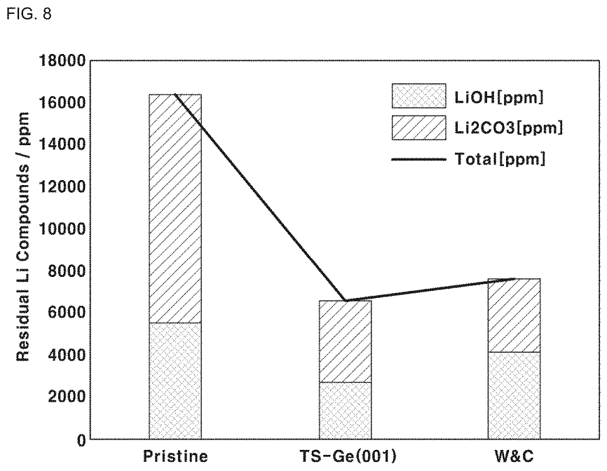

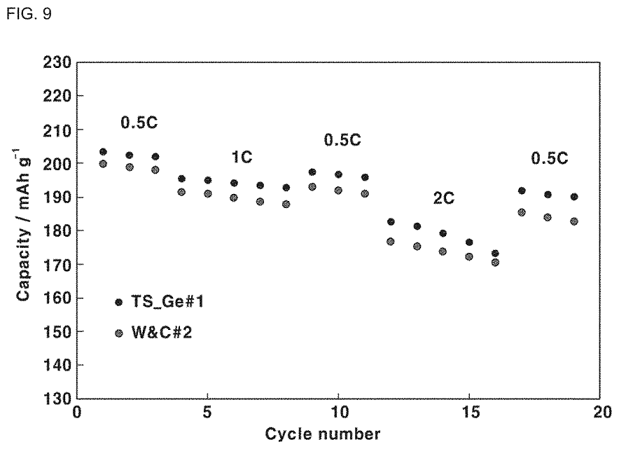

The content of each of the adducts (residual Li compounds) formed on the surfaces of the active materials according to Example 1, Comparative Example 1 and Comparative Example 2 was measured, and FIG. 8 is a graph representing the measured content of the adducts.

Referring to FIG. 8, the content of the adducts formed on the surface of the active material according to Example 1 was reduced by about 63% compared to the content of the adducts formed on the surface of the active material according to Comparative Example 1, and the content of the adducts formed on the active material according to Comparative Example 2 was reduced by about 53% compared to the content of the adducts formed on the surface of the active material according to Comparative Example 1. Consequently, it may be confirmed that the control rate of the adducts formed on the surface of the active material according to Example 1 is superior to the control rate of the adducts formed on the surface of the active material according to Comparative Example 2, in which the washing process and the modification process were independently performed.

### Test Example 3 (Electrochemical Analysis)

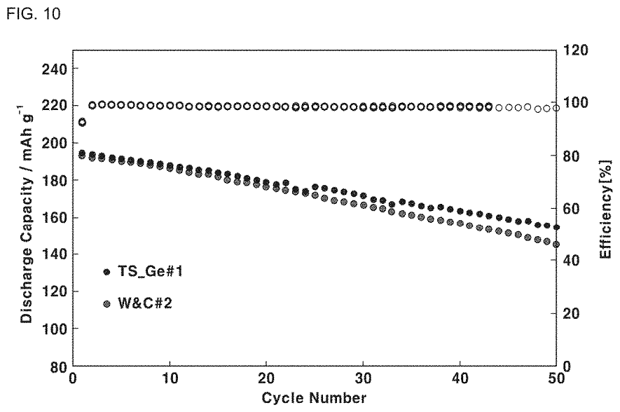

Electrochemical analysis was performed on the active materials according to Example 1 and Comparative Example 2, FIG. 9 is a graph representing the results of observation of rate capabilities of the active materials, and FIG. 10 is a graph representing the results of observation of lifetime characteristics of the active materials.

Referring to FIGS. 9 and 10, the active material according to Example 1, to which germanium (Ge) is applied, shows rate capability and lifetime characteristics equivalent to those of the active material according to Comparative Example 2, to which germanium (Ge) is not applied. It is determined that the reason for this is that the metal oxide particles formed on the surface of the active material according to Example 1 have a small size and are uniformly dispersed.

### Test Example 4 (Control Rate of Adducts)

The content of each of the adducts (residual Li compounds) formed on the surfaces of the active materials according to Comparative Example 1, and Example 1 to Example 3 were measured, and FIG. 11 is a graph representing the measured content of the adducts.

Comparing the results of measurement of the content of each of the adducts formed on the surfaces of the active materials according to Example 2 and Example 3, it may be confirmed that, as the content of a metal source is decreased, the control rate of adducts is improved, and comparing the results of measurement of the content of each of the adducts formed on the surfaces of the active materials according to Example 1 and Example 2, it may be confirmed that as the agitation time is decreased, the control rate of adducts is improved.

### Test Example 5 (Electrochemical Analysis)

Electrochemical analysis was performed on the active materials according to Comparative Example 1 and Example 3, FIG. 12 is a graph representing the results of observation of rate capabilities of the active materials, and FIG. 13 is a graph representing the results of observation of discharge capacities of the active materials.

It may be confirmed that the rate capability of the active material according to Example 3, which is 82.9%, is higher than the rate capability of the active material according to Comparative Example 1, which is 78.5%, and that the discharge capacity of the active material according to Example 3, which is 218.1 mAh g⁻¹, is higher than the discharge capacity of the active material according to Comparative Example 1, which is 216.7 mAh g⁻¹.

### Test Example 6 (Lifetime Characteristics at High Temperature)

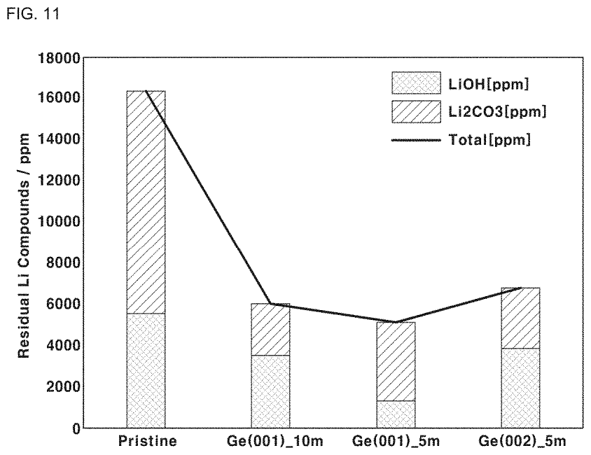

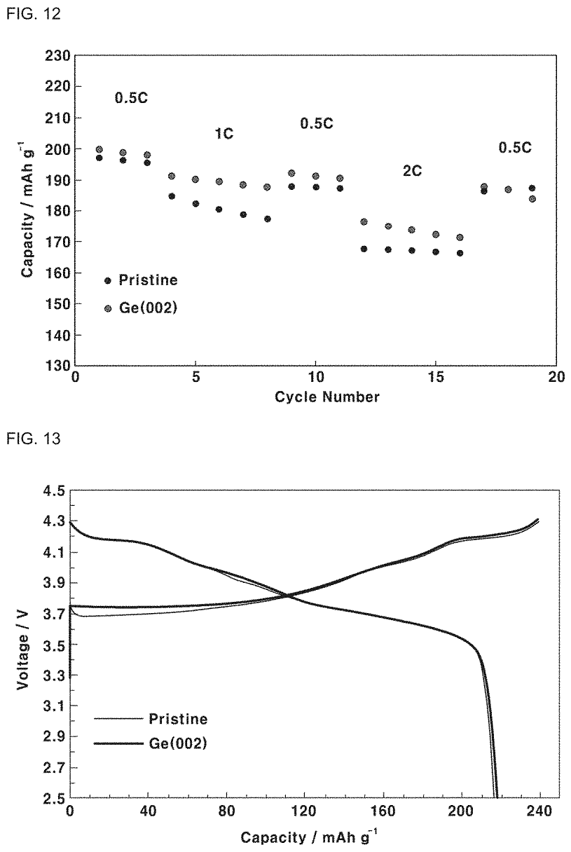

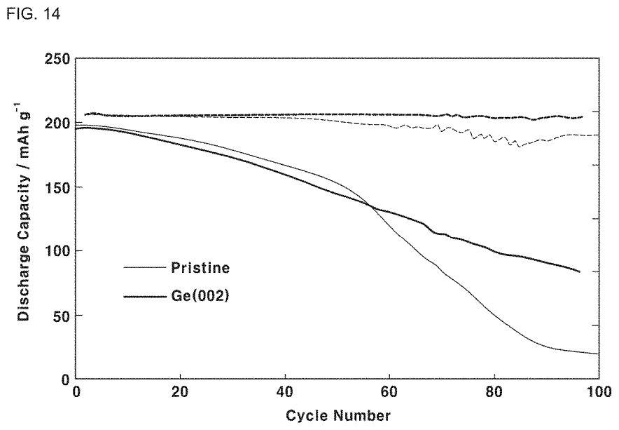

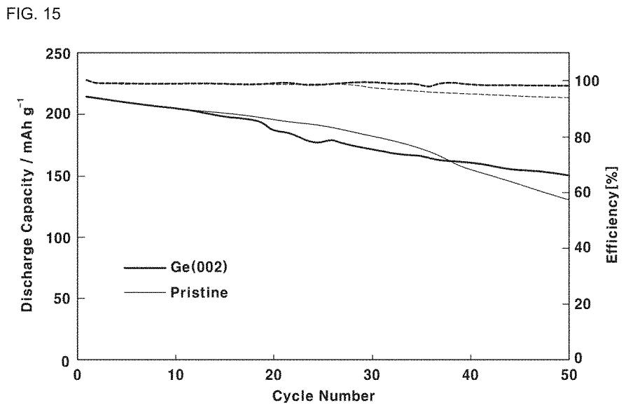

The lifetime characteristics of the active materials according to Comparative Example 1 and Example 3 at room temperature (25° C.) and at a high temperature (45° C.) were compared, and FIGS. 14 and 15 are graphs representing the results of the comparison.

The active material according to Comparative Example 1 shows lifetime characteristics of 9.8% at room temperature and 61.3% at the high temperature, and the active material according to Example 3 shows lifetime characteristics of 42.7% at room temperature and 70.3% at the high temperature.

As is apparent from the above description, the present disclosure provides a method which may effectively remove lithium compounds remaining on the surface of an active material.

The present disclosure provides a method which may modify the surface of an active material so as to form a uniform coating layer on the surface of the active material.

The present disclosure provides a method which may simplify a process for preparing an active material.

The present disclosure provides a method which may simultaneously perform removal of lithium compounds remaining on the surface of an active material and modification of the surface of the active material.

The disclosure has been described in detail with reference to preferred embodiments thereof. However, it will be appreciated by those skilled in the art that changes may be made in these embodiments without departing from the principles and spirit of the disclosure, the scope of which is defined in the appended claims and their equivalents.

What is claimed is:

1. A method for preparing a surface treatment solution, the method comprising:
preparing a mixed solution comprising a metal source, a dispersant, and an organic solvent, wherein the metal source comprises a metal alkoxide;
hydrolyzing the metal source by adding water to the mixed solution; and
performing hydrothermal synthesis in the mixed solution.

2. The method of claim 1, wherein, in the preparing of the mixed solution, the metal source comprises a transition metal element having tetravalent cations.

3. The method of claim 1, wherein, in the preparing of the mixed solution, the metal source comprises one of titanium, germanium, and tin.

4. The method of claim 1, wherein, in the preparing of the mixed solution, the metal alkoxide is one of titanium isopropoxide, germanium isopropoxide, and tin isopropoxide.

5. The method of claim 1, wherein, in the preparing of the mixed solution, the dispersant comprises tetrabutylammonium hydroxide.

6. The method of claim 1, wherein, in the preparing of the mixed solution, the organic solvent comprises at least one selected from the group consisting of isopropanol, ethanol, and acetone.

7. The method of claim 1, wherein, in the hydrolyzing of the metal source, a weight ratio of the organic solvent in the mixed solution to the water is from 2:8 to 4:6.

8. The method of claim 1, wherein, the performing of the hydrothermal synthesis includes allowing hydrothermal reaction to progress in the mixed solution at a temperature of 100 to 180° C. for 0.5 to 3 hours.

9. A surface treatment solution prepared by the method of claim 1, the surface treatment solution comprising:
a solvent comprising the organic solvent and the water; and
a metal oxide comprising one of titanium(IV) oxide, germanium oxide, and tin(IV) oxide.

10. The surface treatment solution of claim 9, wherein the organic solvent comprises at least one selected from the group consisting of isopropanol, ethanol, and acetone.

11. A method for preparing an active material, the method comprising:
preparing a base active material comprising adducts formed on a surface thereof;
preparing an active material mixed solution by mixing the base active material and the surface treatment solution of claim 9;
agitating the active material mixed solution;
obtaining a composite material by removing the solvent from the active material mixed solution; and
heat-treating the composite material.

12. The method of claim 11, wherein, in the preparing of the base active material, the adducts formed on the surface of the base active material comprise lithium carbonate and lithium hydroxide.

13. The method of claim 11, wherein, in the preparing of the base active material, the base active material comprises a lithium metal oxide indicated by Chemical Formula 1 below,
LiₐNiₓMn_{y}M_{1-x-y}O₂, Chemical Formula 1
wherein, a, x and y respectively satisfy 0.9≤a≤1.2, 0.7≤x≤0.95 and 0.01≤y≤0.30, and M comprises one of Co, Al, Mg, Fe, Cu, Zn, Cr, and V.

14. The method of claim 11, wherein, in the preparing of the active material mixed solution, a weight ratio of the base active material to the surface treatment solution is from 1:1 to 1:1.5.

15. The method of claim 11, wherein, the agitating of the active material mixed solution includes removing the adducts from the surface of the base active material by the solvent, and modifying the surface of the base active material by the metal oxide.

16. The method of claim 11, wherein, the agitating of the active material mixed solution includes agitating the active material mixed solution for 6 to 15 minutes.

17. The method of claim 11, wherein, in the obtaining of the composite material, the composite material comprises the base active material and the metal oxide.

18. The method of claim 11, wherein, the heat-treating of the composite material includes heat-treating the composite material at a temperature of from 200 to 600° C. for 1 to 6 hours.

19. The method of claim 11, wherein, the heat-treating of the composite material causes a reaction of the adducts with the metal oxide to produce lithium metal oxide.

20. An active material prepared by the method of claim 11, the active material comprising the metal oxide comprising one of titanium(IV) oxide, germanium oxide, tin(IV) oxide, and a lithium metal oxide.
